(19) United States
(12) Patent Application Publication
(10) Pub. No.: US 2025/0093830 A1
(43) Pub. Date: Mar. 20, 2025

(54) METHOD AND SYSTEM FOR CONTROLLING THE CULTIVATION OF CROPS IN A CROP CULTIVATION SYSTEM

(71) Applicant: PRIVA HOLDING B.V., 2678 LC De Lier (NL)

(72) Inventors: Theodorus Adrianus RIESWIJK, Wateringen (NL); Jan Johannes Wybe WESTRA, s'Gravenzande (NL)

(21) Appl. No.: 18/685,008

(22) PCT Filed: Aug. 25, 2022
(86) PCT No.: PCT/NL2022/050487

§ 371 Date: Feb. 20, 2024

(30) Foreign Application Priority Data
Aug. 25, 2021 (NL) 2029049

(51) Int. Cl. G05B 15/02; A01G 7/04; A01G 9/24; A01G 13/21

(52) U.S. Cl. CPC G05B 15/02; A01G 7/045; A01G 9/246; A01G 9/247; A01G 13/21

(57) ABSTRACT

The disclosure relates to a method of controlling a crop cultivation system (1), comprising creating an ontology (200) with a plurality of objects and relations between the objects. The objects include at least a space object (220) representing a cultivation space (11) of the cultivation system (1) for cultivating crops (2) therein, a crop object (210) representing one or more crops (2) for being cultivated in the cultivation space (11), one or more actuator objects representing one or more actuators of the cultivation system for use in cultivating the one or more crops (2), and a source object representing a source of the cultivation system. The method further comprises determining, based on the ontology (200), one or more control objectives for controlling the cultivation system (1) using the one or more actuators.

### FIELD

The invention relates to a method and system of controlling crop cultivation in a crop cultivation system.

### BACKGROUND

Productivity of cultivated crops is controlled by influencing various climate parameters of the crops' environment. Particularly indoor cultivation systems, where crops are cultivated within an enclosed cultivation space, allow for precise control over the climate in the cultivation space.

Cultivation systems, however, can become very complex as they employ many different climate actuators for manipulating various climate parameters of the climate in the cultivation space. This makes such systems difficult to control. A complicating factor is that each climate actuator, although being configured to influence a primary climate parameter, will often also influence secondary climate parameters. This may be undesirable. For example, electric lights of a cultivation system are primarily designed for providing light to the crops, while they secondarily also generate heat. This cross-coupling further contributes to the complexity of controlling a cultivation system. Also, as each cultivation system is furthermore configured differently, controllers need typically be customised.

### SUMMARY

It is an aim of the invention to provide a method and system for precisely and accurately controlling a crop cultivation system. It is furthermore an aim to provide a user-friendly method and system for controlling a crop cultivation system. It is further an aim to provide a method and system for controlling a crop-cultivation system, which is easily adaptable to different cultivation system configurations.

According to an aspect is provided a method, particularly a computer-implemented method, of controlling a crop cultivation system, comprising creating an ontology with a plurality of objects and relations between the objects. The objects include at least a space object representing a cultivation space of the cultivation system for cultivating crops therein, a crop object representing one or more crops for being cultivated in the cultivation space, one or more actuator objects representing one or more actuators of the cultivation system for use in cultivating the one or more crops, and a source object representing a source of the cultivation system. The method further comprises determining, based on the ontology, a control objective for use in controlling the cultivation system using the one or more actuators.

It will be appreciated that the ontology concerns a model of the cultivation system in a machine-readable form, which enables automated reasoning about the cultivation system. The ontology provides a mapping of the cultivation system, which is modularly scalable and allows for adaptation to different cultivation systems. The ontology shows properties of the cultivation system and how they are related. The cultivation system is in particular reflected as various interacting modules which are represented in the ontology, wherein the objects of the ontology represent the various modules of the cultivation system, and wherein the relations between objects represent causations between those modules. For example, an electric light can be represented by a light object in the ontology, wherein the electric light affects primarily a luminosity of the cultivation space. This primary effect of the electric lights which can be represented in the ontology by, e.g. a primary relation between the light object and the space object. A secondary effect of the electric lights is on a temperature of the cultivation space. This secondary effect can also be included in the ontology by e.g. a secondary relation between the light object and the space object.

The crops are particularly recognised as part, e.g. as a module, of the cultivation system, as the crops interact in various ways with other modules of the system. The influence of the crops on the system is furthermore time-variant, as it depends for instance on a changing activity and growth stage of the crops. For example, the crops influence a humidity of the air in the cultivation space, e.g. depending on the activity of the crops that can vary during a day. Hence, a relation can be for instance be defined in the ontology between the crop object and the space object to represent an actual interaction between the crop and the cultivation space. It will be appreciated that the crop object gives a direct characterisation of the crop or parts of the crop. The crop object, may for example include a theoretical model of the crop representing the dynamics of the crop to various internal and external stimuli.

Each object may have attributes assigned to it in accordance with its associated module. The attributes of an object may reflect particular properties of the module it represents, such as parameter values, e.g. of a mathematical model. Through the relations between the objects, causations between modules of the system can be modelled. The relations are particularly subject to the attributes of the objects. For example, the relations between objects may represent a transfer channel between system modules for the transfer of energy, e.g. heat, or a medium e.g. water, carbon dioxide gas etc., wherein the transfer itself is dictated by module properties which are represented as attributes of the object. Hence, by means of the object attributes, and the interactions between objects, i.e. the relations, an accurate description of the behavior of the cultivation system can be obtained. It will thus be appreciated that the modelled system behavior can be reflected in the ontology by the relations between the objects, subject to the attributes assigned to the objects.

The control objective relates to tasks that are to be accomplished for optimally cultivating the crops. The control objective may be determined by optimising over the ontology, for example to meet a (future) demand, e.g. of the crops, with minimal cost. It will be appreciated that various optimisation algorithms and strategies may be applied for the optimisation. The control objective may particularly be linked to the relations of the ontology. It may for instance concern a transfer between modules of energy, e.g. a transfer of heat, and/or a (mass) transfer of a medium e.g. a transfer of water, or carbon dioxide gas. For instance, the control objective may include one or more of a water evaporation rate of the crops, a water uptake by roots of the crops, an air humidity of the cultivation space, a heat transfer to the cultivation space, solar irradiance, etc., at a certain time instant or during a certain time period.

Optionally, the method comprises determining, based on the control objective, one or more setpoints for one or more controllers for meeting the determined control objective. The one or more setpoints reflect a concretization of the control objective for achieving the determined control objective, such as a desired target value for a module- or system variable, e.g. a desired future state of the modules and cultivation system. Departure from the setpoint may for instance be used for automatic feedback control. The actuators may accordingly be used to drive the system from a current state, at a current time, to the desired future state at a time in the future that meets the control objective.

Optionally, the method comprises determining one or more control actions for the one or more actuators to drive a state of the cultivation system towards the one or more setpoints. The control actions may be determined based on the determined setpoints, and a current state of the cultivation system. The control actions can particularly be determined by a central control unit, and/or by decentralised controllers.

Optionally, the control objective is determined by optimising over the ontology to meet a future demand of the crops at minimum cost. The method for example includes predicting an activity capacity of the crops at a time in the future. This future activity capacity can be predicted using the ontology, in particular by using the crop object, which may have crop attributes assigned thereto. The ontology can subsequently be optimised to meet this future demand of the crops with minimum cost. This optimisation can accordingly result in a control objective, based on which one or more setpoints can be determined. The actuators can be controlled accordingly. It will be appreciated that cost may be defined in various ways. For instance, cost may defined as an effort to meet the control objective. Cost may thus be directly related to the control objective. Cost may for example be expressed as a demand of resources to meet the control objective, such as an energy demand and/or a medium demand.

A real activity of the crops, or at least an estimation thereof, may be determined using one or more sensors of the cultivation system. The sensors may be represented by separate objects in the ontology, may be comprised by other objects, or may not be represented in the ontology at all. For instance, a cultivation space module may include a temperature sensor for measuring a temperature of the air in the cultivation space. The sensors can thus provide an indication of a real activity of the crops, such as an evaporation rate, assimilation rate, absorption rate, etc.

Optionally, the control objective is determined based on a prediction of a capacity of activity of the crops at a time in the future. The capacity of activity may for instance be represented in the ontology as an attribute of the crop object. Capacity of activity of the crops relates to an activity potential of the crops, and may include an evaporation capacity, an absorption capacity, an assimilation capacity, dissimilation capacity, etc. The capacity of activity of the crops may for example be determined using a theoretical model of capacity of activity of the crops over time. The theoretical capacity of activity of the crops may be associated with a biological rhythm of the crops, e.g. a circadian rhythm of the crops. An appropriate control objective for the future crop capacity of activity can accordingly be determined, by optimising over the ontology.

Optionally, the control objective is determined for which a difference is minimised between a theoretical capacity of activity of the crops at a time in the future, and a prediction of the activity of the crops at said time in the future, given an indication of a current activity of the crops at a current time.

Optionally, the theoretical capacity of activity is adapted in case a real current and/or past activity of the crops is dissimilar from an expected activity of the crops for the current time and/or past time, e.g. in case a development of the crop at the current time lags behind an expected development of the crop at the current time. A future activity capacity of the crops depends on a current activity of the crops, and hence a prediction of a future activity capacity of the crops can be adapted accordingly. It will be appreciated that the real activity of the crops may be determined indirectly from measurements. Hence at least an indication of the real activity may be used for determining the control objective.

Optionally, the control objective is determined for a predefined finite time-horizon into the future. The time-horizon may for example be in the order of hours or days, e.g. 1, 6, 12, 24, 36, 48, or 72 hours or anything therebetween.

Optionally, the method includes controlling the cultivation system in accordance with the determined control objective for a predefined time-period which is shorter than the time-horizon. Optionally, a new control objective may be determined, wherein after expiry of the predefined time-period, the cultivation system is controlled in accordance with the determined new control objective. It will be appreciated that the new control objective may be determined in similar way as a previous control objective, e.g. for the predefined finite time-horizon into the future. It will furthermore be appreciated that the cultivation system may also be controlled in accordance with the determined new control objective for said predefined time-period which is shorter than the time-horizon. The new control objective may be different from a previously determined control objective, for example in case a state of the cultivation system has progressed. A mismatch between the ontology and the real cultivation system is accounted for by optimising a finite time period into the future, and controlling the system according to the determined control objective during a predefined finite time-period into the future. After expiry of this time-period, the current time and the time-horizon have shifted correspondingly, and the ontology is again optimised for the predefined time-horizon to determine a new control objective. Control setpoints, and control actions, may be determined accordingly based on the determined control objective. This process can be repeated multiple times.

The optimisation may be subjected to constraints. Constraints can correspond to physical limits of the devices of the cultivation system. Such hard constraints may for example be assigned as attributes to the objects of the ontology. Also, soft constraints can be imposed on the optimisation, e.g. by penalizing certain solutions. This could increase the feasibility of the optimisation. Soft constraints may also be assigned as attributes to the objects of the ontology.

Optionally, the theoretical capacity of activity is adapted in case a real current and/or past activity of the crops is dissimilar from an expected activity of the crops for the current time and/or past time, e.g. in case a development of the crop at the current time lags behind an expected development of the crop at the current time. A future activity capacity of the crops depends on a current activity of the crops, and hence a prediction of a future activity capacity of the crops can be adapted accordingly. It will be appreciated that the real activity of the crops may be determined indirectly from measurements. Hence at least an indication of the real activity may be used for determining the control objective.

Optionally, the one or more actuator objects represent hardware components of one or more of a sun-shade device, electric light device, heating device, cooling device, water supply device

Optionally, the source object represents one or more of an energy source object and a consumable source.

Optionally, the source object represents one or more of a weather object, gas source object, electricity object, and a water supply object.

Optionally, the source object represents one or more of a water source object, gas source object, electricity source object and solar radiation source object.

Optionally, the relations of the ontology represent a transfer between objects of crop consumables, in particular, water, nutrients, carbon dioxide, oxygen, light, heat, protection agents, and regulator agents.

Optionally, the relations represent a transfer of energy between the objects.

Optionally, the relations between objects are linear or linearized. Hence, computational cost can be reduced. Furthermore, linear(ized) relations preserves a superposition property in the ontology. More particular, at least some of the objects may include a dynamic model, e.g. a set of differential equations, wherein the dynamic model is linear or linearizable. The object models can for example be linearized around an operating regions.

According to a further aspect is provided a computer-implemented method of modelling a crop cultivation system. The method comprises creating an ontology with a plurality of objects and relations between said objects, wherein the objects include at least a space object representing a cultivation space of the cultivation system for cultivating crops therein, a crop object representing one or more crops for being cultivated in the cultivation space, one or more actuator objects representing one or more actuators of the cultivation system for use in cultivating the one or more crops, and a source object representing a source of the cultivation system. Such modelling, not only facilitates the control of crop cultivation systems, it furthermore assists in designing and/or optimising a configuration of crop cultivation systems. The ontology can for example be used to determine improvements in the configuration of existing cultivation systems, e.g. by optimising the ontology for meeting predefined demands.

According to a further aspect is provided a device arranged for carrying out a method as described herein.

A further aspect provides a computer program product and a computer-readable medium comprising instructions which, when executed by a computer, cause the computer to carry out a method as described herein.

According to another aspect is provided a crop cultivation system, e.g. a crop cultivation system arranged for carrying out a method as described herein, comprising a cultivation space module for cultivating crops; a crop module of one or more crops to be cultivated in the cultivation space module; one or more actuator modules for use in cultivating the crops; and an optimiser comprising an ontology of the cultivation system having a plurality of objects and relations between the objects, wherein the objects include at least a space object representing the cultivation space module, a crop object representing the crop module, and one or more actuator objects representing the one or more actuator modules; wherein the optimiser is configured to determine a control objective for controlling the cultivation system using the one or more actuators, based on the ontology.

It will be appreciated that any one or more of the above aspects, features and options can be combined. It will be appreciated that any one of the options described in view of one of the aspects can be applied equally to any of the other aspects. It will also be clear that all aspects, features and options described in view of the methods apply equally to the devices and systems.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIG. 1 shows a crop cultivation system;

FIG. 2 shows an exemplary ontology graph of a crop cultivation system;

FIG. 3 shows an exemplary ontology graph of a crop cultivation system.

### DETAILED DESCRIPTION

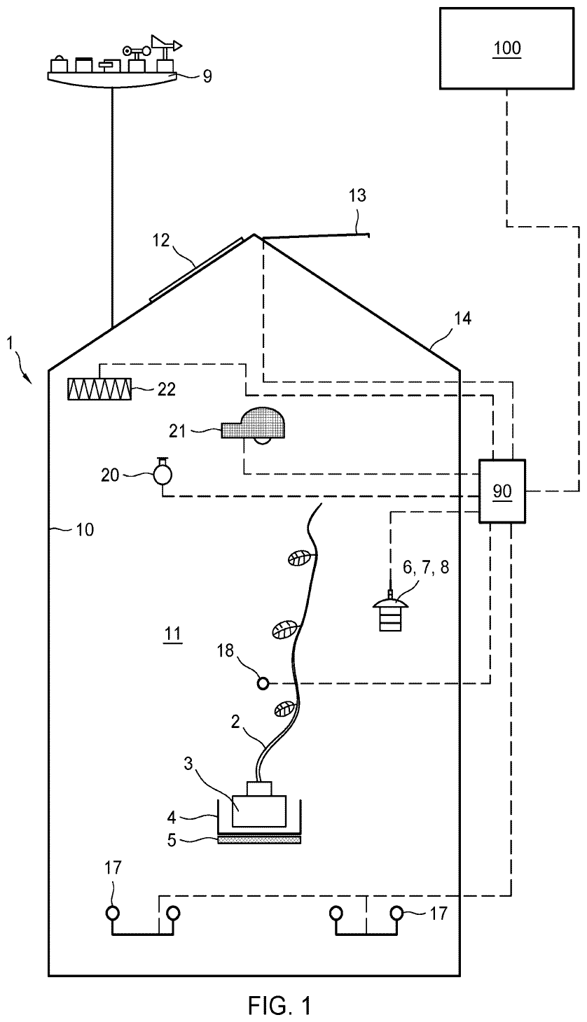

FIG. 1 shows an example of a crop cultivation system 1. The cultivation system includes an enclosure 10 defining a cultivation space 11. Crops 2 are cultivated in the cultivation space. The system 1 comprises various devices for use in cultivating the crops 2, such as sensors and actuators.

For example, the crops 2 have roots in a substrate 3 which is arranged on a substrate gutter 4. To determine a gain or loss of weight of the crops 2 and substrate 3, the crops 2 are arranged on a weight sensor 5. Temperature and humidity of the air within the cultivation space 11 is measured respectively by air temperature sensor 6 and air humidity sensor 7, and CO2 concentration of the air in the space 11 is measured using CO2 sensor 8. Air temperature, humidity, solar radiation, wind direction and wind speed outside of the greenhouse may be measured by a weather station 9 provided on a roof 14 of the enclosure.

The enclosure includes windows 12, 13, 14 which are movable between an open and a closed position using a window actuator. When the window 13 is opened, air from within the cultivation space 11 can be exchanged with air from outside in order to adjust a temperature, air humidity and/or a CO2 concentration within the space 11.

The cultivation system also comprises heating tubes 17 arranged at a lower side of the plants 2. The heating tubes are arranged transfer heat to the air of the cultivation space 11, if needed. A carbon-dioxide supply tube 18 is arranged at a lower side of the plants 2 and adapted for provide carbon-dioxide gas to the cultivation space 11 to regulate plant development. The system further comprises a sun-shade arrangement 22 which comprises a screening cloth that can be in a substantially retracted position, as shown, in which the cloth substantially does not block sunlight that passes from through the roof from directly reaching the crops, and an extended position in which the screening cloth spans across the roof and substantially blocks light that passes through the roof 14 from directly reaching the crops 2. The sun-shade arrangement 22 can accordingly be used to regulate an air temperature in the cultivation space 11, as well as a luminosity of the cultivation space 11. Further, the system includes electric grow lights 21 for emitting light in the cultivation space 11, and a water atomizer 20, for increasing the air humidity and providing adiabatic cooling in the cultivation space 11.

Various climate parameters, e.g. temperature, air humidity, and carbon-dioxide concentration in the cultivation space 11 can be controlled using the various actuators of the cultivation system 1, to optimize crop development. For example, a position of the window 13, a position of the screening cloth, heat-supply from the heating tubes 17, and carbon-dioxide supply by supply tube 18, can be controlled, for example by a central control unit and/or decentralized controllers.

Here, the devices of the cultivation system are connected to a control unit 100, in this case via a hub unit 90. The control unit 100 includes an optimizer. The control unit 100 may be remote from the cultivation system 1, but can also be, e.g. partly, at or near the cultivation system 1. The control unit 100 is arranged to receive data from the devices, indicative of an activity of the crops, and automatedly determine a control objective based thereon. The control unit 100 is also arranged, in this example, to automatedly determine, based on the control objective, one or more setpoints for controlling the actuators. The setpoints can be send to the one or more actuators of the cultivation system, here via the hub unit 90, for example to be used by a local controller of the actuator. The control unit 100 comprises an ontology representing the cultivation system 1, wherein the control objective is automatedly determined based on the ontology.

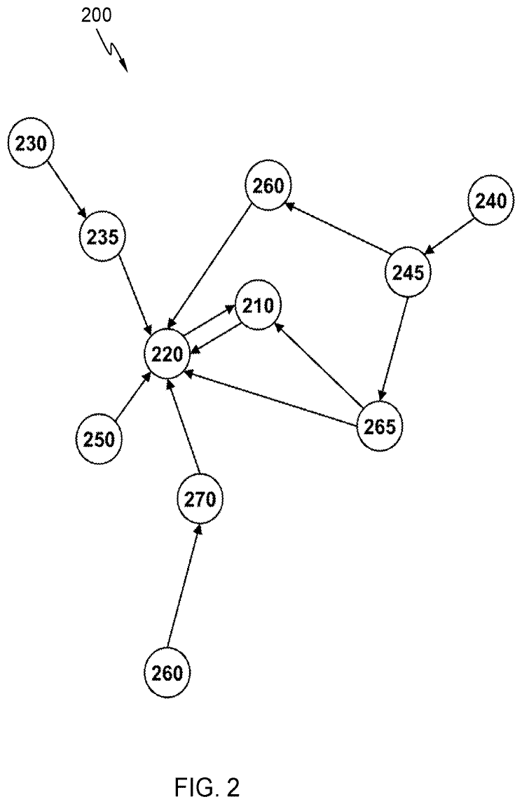

FIG. 2 shows an example of an ontology 200 of a crop cultivation system. The ontology 200 here particularly represents, although simplified for clarity, a mapping of the crop cultivation system 1 as shown in FIG. 1. The ontology 200 could therefore be regarded as a domain ontology, representing the domain of a crop cultivation system. The ontology 200 comprises a plurality of objects representing respective devices, or components of devices, of the cultivation system 1. Relations are defined between the objects of the ontology 200, representing causations between the devices of the cultivation system 1. In FIG. 2, the relations between objects are indicated by arrows. The direction of the arrows indicate a directional component of the relation. The relations for example represent a transfer of energy and/or resources between devices, wherein the arrow indicates a direction of transfer. Attributes are assigned to each of the objects, representing features and characteristics of their associated devices of the cultivation system 1. For example, each object may include a model of the associated device with corresponding model parameters. The attributes, e.g. the model parameters may be adapted to improve the accuracy of the ontology. For example, the model parameters may be estimated in view of observed responses of the system. Hence object attributes may be updated, e.g. online.

The ontology 200 particularly includes a crop object 210, representing the crops 2. It will be appreciated that the crops 2 are recognized as being an (organic) device of the cultivation system 1. The crop object 210 may include a (sub) ontology representing the crop. It will be appreciated that the crop object 210 may represent a single plant or multiple plants.

The ontology also includes a space object 220, representing the cultivation space 11 of the cultivation system 1. The space object 220 has space attributes assigned thereto.

The ontology 200 further includes source objects representing, here an electricity source object 230, a gas source object 240, a weather object 250, and a water source object 260. The source objects represent respective sources, e.g. energy sources and consumable resources for the system 1. The source objects may have source attributes assigned thereto, for example a price of the sources, e.g. a gas price, electricity price, water price. Such attributes may be updated regularly.

The gas source object 240 is here connected to a boiler object 245, i.e. a relation is defined between the gas source object 240 and the boiler object 245, representing a causation between the gas source and the boiler of the cultivation system. Here, the relation represents a transfer of gas from the gas source to the boiler. The boiler object 245, in this example, receives gas from the gas source 240, and transforms the received gas into heat and carbon dioxide, in accordance with boiler attributes of the boiler 245 which are assigned to the boiler object 245. A further relation is defined between the boiler object 245 and a carbon-dioxide supply object 260 which represents the carbon-dioxide supply tube 18 of the cultivation system 1. Here, the relation represents a transfer of carbon-dioxide gas from the boiler to the carbon-dioxide supply tubing 18. The carbon-dioxide supply object 260 may have carbon-dioxide supply attributes assigned thereto, such as dimensions of the tubing, valves, pressures, etc. The heat produced by the boiler is supplied to the heating tubes 17, indicated by the relation between the boiler object 245 and a heating tubes object 265. The heating tubes object 265 may also have heating tubes attributes assigned thereto.

From the carbon-dioxide supply tubing, carbon-dioxide gas is supplied to the cultivation space 11, represented in the ontology by the relation between the carbon-dioxide supply object 260 and the space object 220. Similarly, heat is transferred from the heating tubes to the cultivation space, represented by the relation in the ontology between the heating tubes object 265 and the cultivation space object 220. Also, heat from the heating tubes 7 may be directly transferred to the crops 2, e.g. to roots of the crops 2, which is indicated in FIG. 2 by the relation between the heating tubes object 265 and the crop object 210.

From the water source, water is transferred to a water supply represented by a relation between the water source object 260 and a water supply object 270. In this example the water supply object 260 represents watering devices for providing water to the substrate in which the crops are cultivated. A separate water supply may be provided for providing water to the water atomizer 20 for influencing a humidity in the cultivation space. It will be appreciated that such devices may be represented by dedicated objects in the ontology. The water supply may thus include piping, valves, taps, distributors, nozzles, etc, each having attributes that can be assigned to the water supply object 270. Water is thus transferred from the water supply to the cultivation space to influence the cultivation space 11 and substrate 3 in several ways.

From the electricity source, electricity is transferred to lighting including one more electric lights 21, corresponding to the relation defined between the electricity source object 230 and a lighting object 235. The lighting object transfers electric power to light, which light is transmitted in the cultivation space 11. Hence, the lighting influences the cultivation space 11 represented in the ontology 200 by a relation between the lighting object 235 and the space object 220. Here, the lighting object 235 includes various electrical components of an electric circuit of the cultivation system, which may be assigned as attributes to the lighting object 235. It will be appreciated that an electricity circuit object may be included between the electricity source object and the lighting object, representing an electric circuit of the cultivation system.

Weather object 250 represents a source of weather, e.g. ambient temperature, ambient air humidity, sun irradiance, etc. The weather object 25 may include a current weather information, but also weather forecast information for a time in the future. The weather has an influence on the cultivation space, reflected by relation defined between the weather object 250 and the cultivation space object 220.

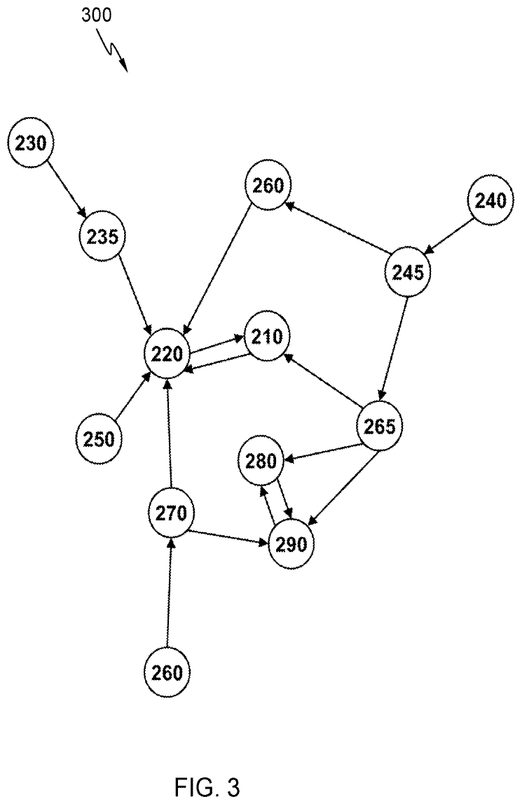

FIG. 3 shows another example of an ontology 300, which similar to the ontology of FIG. 2, but further includes a further crop object 280, and a further cultivation space 290. In this example, relations are defined between the water supply object 270 and the cultivation space 290, between the heating tubes object 265 and the crop object 280, and between the heating tubes object 265 and the space object 280. This ontology example may reflect a cultivation system in which further crops are cultivated in a further cultivation space, wherein the heating tubes 17 are configured to heat the crops, and the cultivation space, and wherein water is supplied to the cultivation space by the water supply. The further crops are, in this example, not subjected to light, carbon-dioxide and weather influences, for instance because the further cultivation space is not connected to such provisions. It will however be appreciated that the ontology can be adapted to any configuration of the cultivation system.

It will also be appreciated that accuracy of the ontology, with respect to the actual cultivation system, can be increased by, e.g. adding additional objects and relations to model (sub) modules of the cultivation system. Further, each object to of the ontology may include a model of the device or module it represents, e.g. a set of differential equations, reflecting dynamics of the device or module.

Using the ontology, the control unit 100 can compute, e.g. automatedly, a control objective. The control objective can include desired conditions of the cultivation space, e.g. comfort parameters for providing optimal growth conditions for the crops in the cultivation space. The control objective for example include a heat supply, or a water vapor supply to cultivation space. Based on the control objective, one or more setpoints can be determined, such as a temperature of heating tubes 17, a flow-rate or pressure of the water atomiser 20, a light intensity of the light 21, etc. The control objective is particularly computed by optimising the ontology, to meet a future demand of the crops with minimum cost. The optimisation problem includes for example a minimisation of a difference between a theoretical capacity of activity of the crops at a time in the future, and a prediction of a real activity of the crops at said time in the future, given an indication of a real current activity of the crops at a current time. The control objective is determined for a predetermined finite time-horizon.

Based on the control objective, an appropriate set of control setpoints can be computed, e.g. automatedly. Subsequently, control actions can be executed for driving the process to meet the control objective.

The control setpoints and/or the control actions may be send, e.g. wirelessly, from the control unit 100, to the hub unit 90. From the hub-unit individual actuators can be operated, e.g. by sending a signal from the hub unit 90 to the actuators. Each actuator may include a dedicated controller, but the cultivation system may also include a centralized controller for controlling the actuators.

The cultivation system is controlled according to the determined control objective, e.g. operated with the associated control actions, for a predefined operational time-period. This operational time-period is shorter than the predetermined time-horizon. After expiry of the operational time-period, the optimisation is performed again. Hence, a new control objective is determined for which, given a current real activity of the crops, a difference between an estimated real future activity of the crops at a predefined finite time-horizon relative to the current time and a theoretical capacity of activity at said time-horizon is minimised, with minimum cost. This process can be repeated multiple times.

Herein, the invention is described with reference to specific examples of embodiments of the invention. It will, however, be evident that various modifications, variations, alternatives and changes may be made therein, without departing from the essence of the invention. For the purpose of clarity and a concise description features are described herein as part of the same or separate embodiments, however, alternative embodiments having combinations of all or some of the features described in these separate embodiments are also envisaged and understood to fall within the framework of the invention as outlined by the claims. The specifications, figures and examples are, accordingly, to be regarded in an illustrative sense rather than in a restrictive sense. The invention is intended to embrace all alternatives, modifications and variations which fall within the spirit and scope of the appended claims. Further, many of the elements that are described are functional entities that may be implemented as discrete or distributed components or in conjunction with other components, in any suitable combination and location.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A method of controlling a crop cultivation system, comprising
creating an ontology with a plurality of objects and relations between the objects, wherein the objects include at least a space object representing a cultivation space of the cultivation system for cultivating crops therein, a crop object representing one or more crops for being cultivated in the cultivation space, one or more actuator objects representing one or more actuators of the cultivation system for use in cultivating the one or more crops, and a source object representing a source of the cultivation system; and
determining, based on the ontology, one or more control objectives for use in controlling the cultivation system using the one or more actuators.

2. The method of claim 1, comprising determining, based on the control objective, one or more setpoints for one or more controllers for meeting the determined control objective.

3. The method of claim 2, comprising determining one or more control actions for the one or more actuators for driving a state of the cultivation system towards the one or more setpoints.

4. The method of claim 1 is slim, wherein the control objective is determined by optimising over the ontology to meet a future demand of the crops at minimum cost.

5. The method of claim 1, wherein the control objective is determined based on a theoretical capacity of activity of the crops.

6. The method of claim 1, wherein the control objective is determined for which a difference is minimised between a theoretical capacity of activity of the crops at a time in the future, and a prediction of a real activity of the crops at said time in the future, given an indication of a current activity of the crops at a current time.

7. The method of claim 6, wherein the theoretical capacity of activity of the crops is adapted in case a real current and/or past activity of the crops is dissimilar from an expected activity of the crops for the current time and/or past time.

8. The method of claim 1, wherein the control objective is determined for a predefined finite time-horizon into the future.

9. The method of claim 8, wherein the method includes controlling the cultivation system according to the determined control objective for a predefined time-period which is shorter than the time-horizon.

10. The method of claim 1, wherein the one or more actuator objects comprise one or more of a sun-shade object, electric light object, heating device object, cooling device object, water device object.

11. The method of claim 1, wherein the source object comprises an energy source object and/or a consumable source.

12. The method of claim 11, wherein the source object includes one or more of a weather object, gas source object, electricity object, a water supply object.

13. The method of claim 12, wherein the source object includes one or more of a water source object, gas source object, electricity source object and solar radiation object.

14. The method of claim 1, wherein the relations comprise a transfer between objects of crop consumables, in particular, water, nutrients, carbon dioxide, oxygen, light, heat, protection agents.

15. The method of claim 1, wherein the relation comprise a transfer of energy between the objects.

16. The method of claim 1, wherein the relations between objects are linear or linearized.

17. A computer-implemented method of modelling a crop cultivation system, comprising creating an ontology with a plurality of objects and relations between said objects, wherein the objects include at least:
a space object representing a cultivation space of the cultivation system for cultivating crops therein,
a crop object representing one or more crops for being cultivated in the cultivation space,
one or more actuator objects representing one or more actuators of the cultivation system for use in cultivating the one or more crops, and
a source object representing a source of the cultivation system.

18. (canceled)

19. (canceled)

20. A non-transitory computer-readable medium comprising instructions which, when executed by a computer, cause the computer to:
create an ontology with a plurality of objects and relations between the objects, wherein the objects include at least a space object representing a cultivation space of a cultivation system for cultivation crops therein, a crop object representing one or more crops for being cultivation in the cultivation space, one or more actuator objects representing one or more actuators of the cultivation system for use in cultivating the one more crops, and a source objects representing a source of cultivation system; and
determine, based on the ontology, one or more control objectives for use in controlling the cultivation system using the one or more actuators.

21. A crop cultivation system, comprising
a cultivation space module for cultivating crops;
a crop module of one or more crops to be cultivated in the cultivation space module;
one or more actuator modules for use in cultivating the crops; and
an optimiser comprising an ontology of the cultivation system having a plurality of objects and relations between the objects, wherein the objects include at least a space object representing the cultivation space module, a crop object representing the crop module, and one or more actuator objects representing the one or more actuator modules; wherein the optimiser is configured to determine one or more control objectives for controlling the cultivation system using the one or more actuators, based on the ontology.
